(19) United States
(12) Patent Application Publication
(10) Pub. No.: US 2011/0248957 A1
(43) Pub. Date: Oct. 13, 2011

(54) MOBILE DEVICE HAVING TOUCH SCREEN PANEL AND METHOD FOR MANAGING THE SAME

(75) Inventor: Jae Woon Park, Suwon-si (KR)

(73) Assignee: Samsung Electronics Co., Ltd., Suwon-si (KR)

(21) Appl. No.: 13/085,285

(22) Filed: Apr. 12, 2011

(30) Foreign Application Priority Data
Apr. 12, 2010 (KR) 10-2010-0033281

(51) Int. Cl. G06F 3/045

(52) U.S. Cl. 345/174

(57) ABSTRACT

A mobile device includes a touch screen panel having first and second terminals. When a touch is inputted, the touch screen panel creates a resistance between the first and second terminals. The mobile device further includes first and second switches and an output unit. The first switch is connected at one end thereof to the first terminal and connected at the other end thereof to a power supply and a processor. The second switch is connected at one end thereof to the second terminal and grounded at the other end thereof. In a sleep mode, the processor closes the first and second switches, measures a voltage at a connection point with the first switch, and determines whether the measured voltage is varied. If the measure voltage is varied and its duration is greater than a critical time, the processor controls the output unit to output a vibration or sound.

### CROSS-REFERENCE TO RELATED APPLICATION(S) AND CLAIM OF PRIORITY

The present application is related to and claims the benefit under 35 U S.C. §119 a of a Korean patent application filed in the Korean Intellectual Property Office on Apr. 12, 2010 and assigned Serial No. 10-2010-033281, and the entire disclosure of which is hereby incorporated by reference.

### TECHNICAL FIELD OF THE INVENTION

The present invention relates in general to a mobile device and, more particularly, to a mobile device having a touch screen panel of a resistive type and also a method for managing the touch screen panel to prevent improper operations or troubles caused by unexpected conditions in which the touch screen panel is lengthily pressed down.

### BACKGROUND OF THE INVENTION

A touch screen panel is a flat, usually rectangular element that is attached to the surface of a display device, detects a physical touch of the finger or a stylus pen, and converts it to an electric signal. Normally the touch screen panel is applied to a liquid crystal display (LCD), a plasma display panel (PDP), an electro-luminescence (EL) device, and the like.

The touch screen panel is classified into a capacitive type, a resistive type, an ultrasonic wave type, an infrared type, and the like, depending on its operation principles. Among them, a resistive type is widely used for mobile devices launched currently.

As shown in FIG. 1, a conventional touch screen panel of a resistive type is composed of an upper substrate 110 and a lower substrate 120. In order to keep a gap between the upper and lower substrates 110 and 120, a plurality of dot spacers 130 are disposed at regular intervals on the lower substrate 120. The upper and lower substrates 110 and 120 are joined together with an adhesive layer 140. Each of the substrates 110 and 120 is composed of an insulating base 111 and 121 and an indium tin oxide (ITO) layer 112 and 122. In this structure, when an external physical force (namely, a user's touch action) is applied to a certain point on the upper substrate 110, the ITO layer 112 of the upper substrate 110 is locally pressed down and then comes in contact with the ITO layer 122 of the lower substrate 120. Therefore, a device having, the touch screen panel recognizes the X and Y coordinates of a contact point and finds a touch position.

When a user carries a mobile device in his or her pocket, the touch screen panel of the mobile device may receive undesired pressure for a long time. Due to such unfavorable conditions in which the touch screen panel is lengthily pressed down, the mobile device may often fail to reliably keep a gap between ITO layers 112 and 122 of the upper and lower substrates 110 and 120, thus unexpectedly causing improper operations or troubles of the touch screen panel.

### SUMMARY OF THE INVENTION

To address the above-discussed deficiencies of the prior art, it is a primary object to provide a mobile device having a touch screen panel and a method for managing the touch screen panel to prevent improper operations or troubles caused by unexpected conditions in which the touch screen panel is lengthily pressed down.

According to one aspect of the present invention, a mobile device is provided. The mobile device includes a touch screen panel having a first terminal and a second terminal and configured to create a resistance between the first and second terminals when a touch is inputted thereon. The mobile device also includes a power supply configured to generate a voltage. The mobile device further includes a processor configured to measure a voltage at a connection point with the power supply in a sleep mode, when the measured voltage is varied, to measure the duration of the varied voltage, and then to determine whether the measured duration is greater than a predefined critical time. The mobile device also includes a first switch connected at one end thereof to the first terminal, connected at the other end thereof to both the power supply and the processor, and closed in the sleep mode. The mobile device further includes a second switch connected at one end thereof to the second terminal, grounded at the other end thereof, and closed in the sleep mode. The mobile device also includes an output unit configured to output at least one of a vibration and a sound when the measured duration is greater than the critical time.

According to another aspect of the present invention, a method for managing a touch screen panel of a mobile device is provided. The mobile device includes the touch screen panel having a first terminal and a second terminal, a power supply, a processor, a first switch connected at one end thereof to the first terminal and connected at the other end thereof to both the power supply and the processor, and a second switch connected at one end thereof to the second terminal and grounded at the other end thereof. The method includes closing the first and second switches in a sleep mode. The method also includes measuring a voltage at a connection point with the first switch. The method further includes determining whether the measured voltage is varied. The method also includes, when the measured voltage is varied, measuring the duration of the varied voltage. The method further includes outputting at least one of a vibration and a sound when the measured duration is greater than a predefined critical time.

According to aspects of this invention, by warning a user that an undesired pressure is continuously applied on the touch screen panel, the mobile device can effectively prevent improper operations or troubles of the touch screen panel and also can favorably protect the touch screen panel. Therefore, this may reduce repair costs normally incurred and also can allow service operators to manage a cost-effective service.

Other aspects, advantages and salient features of the invention will become apparent to those skilled in the art from the following detailed description, which, taken in conjunction with the accompanying drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a conventional touch screen panel of a resistive type;

FIG. 2 illustrates a configuration of a mobile device that includes a touch screen panel in accordance with an embodiment of the present invention;

FIG. 3A illustrates a configuration of a touch screen panel in accordance with an embodiment of the present invention;

FIGS. 3B and 3C illustrate operation principles of a touch screen panel in accordance with an embodiment of the present invention;

FIG. 4 illustrates a configuration of a control unit of a mobile device in accordance with an embodiment of the present invention;

FIG. 5 illustrates a method for managing a touch screen panel in accordance with an embodiment of the present invention; and

FIG. 6 illustrates a configuration of a control unit of a mobile device when first and second switches thereof are closed in accordance with an embodiment of the present invention.

### DETAILED DESCRIPTION OF THE INVENTION

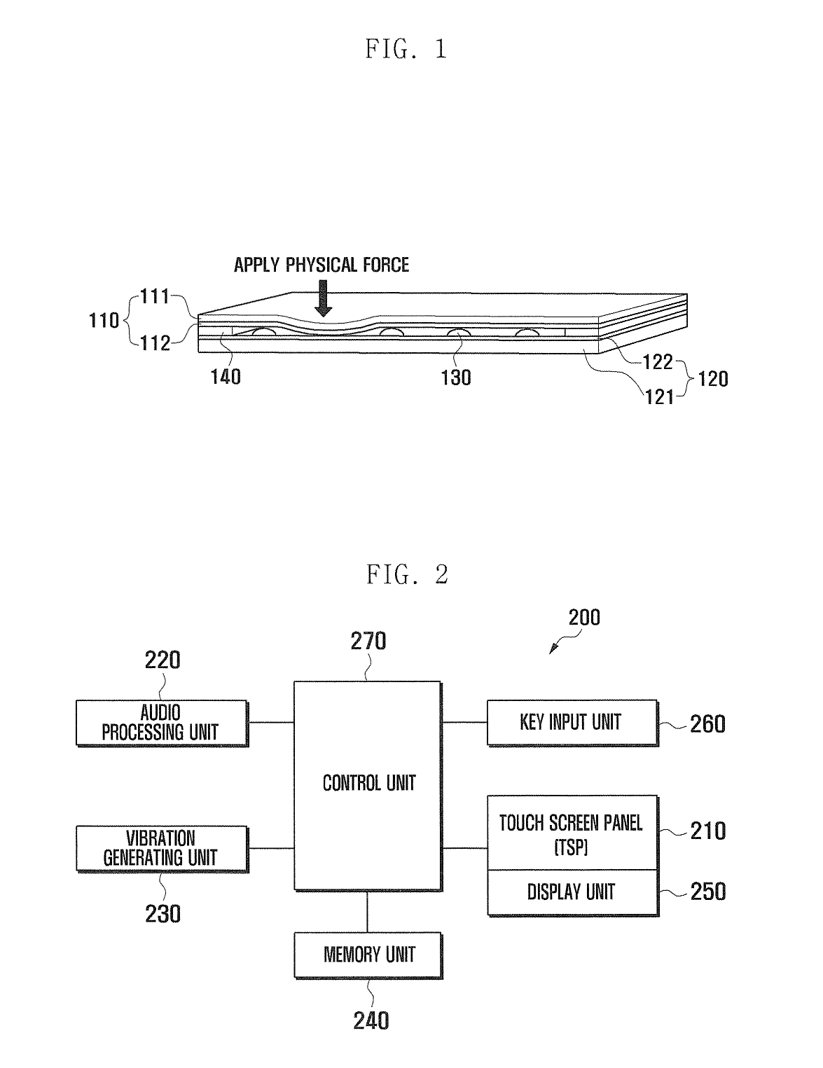

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

A mobile device according to embodiments of this invention refers to any electronic device that includes a touch screen panel of a resistive type, preferably including a mobile communication device, a handheld phone, a personal digital assistant (PDA), a smart phone, an IMT-2000 (International Mobile Telecommunication 2000) device, a CDMA (Code Division Multiple Access) device, a WCDMA (Wideband CDMA) device, a GSM (Global System for Mobile communication) device, a GPRS (General Packet Radio Service) device, an EDGE (Enhanced Data GSM Environment) device, a UMTS (Universal Mobile Telecommunication Service) device, a digital broadcasting receiver, an ATM (Automated Teller Machine), and any other applications thereof.

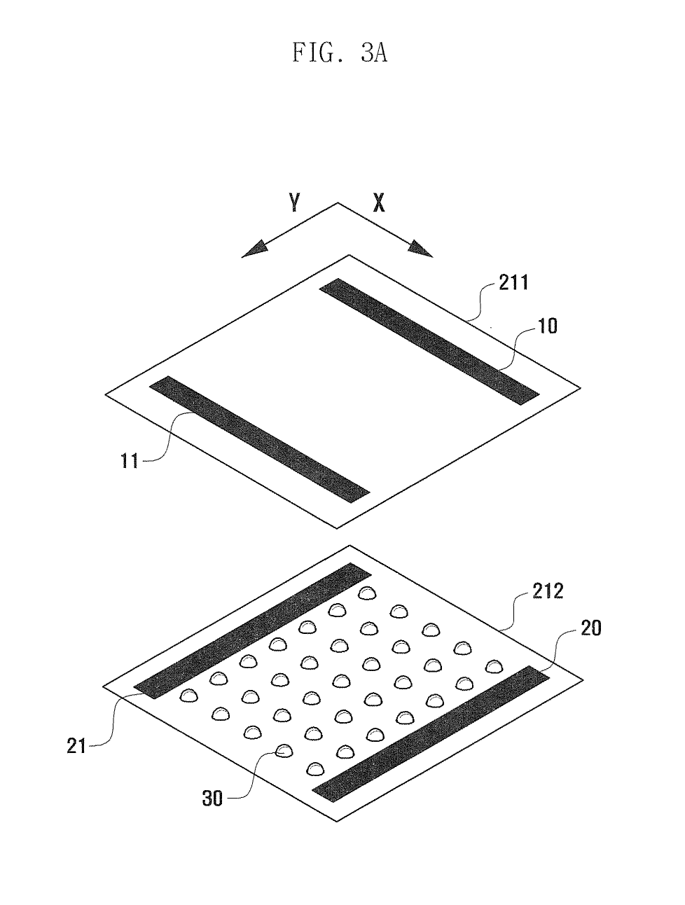

FIG. 2 is a block diagram illustrating the configuration of a mobile device that includes a touch screen panel in accordance with an embodiment of the present invention. Referring to FIG. 2, the mobile device 200 includes the touch screen panel (TSP) 210, an audio processing unit 220, a vibration generating unit 230, a memory unit 240, a display unit 250, a key input unit 260, and a control unit 270.

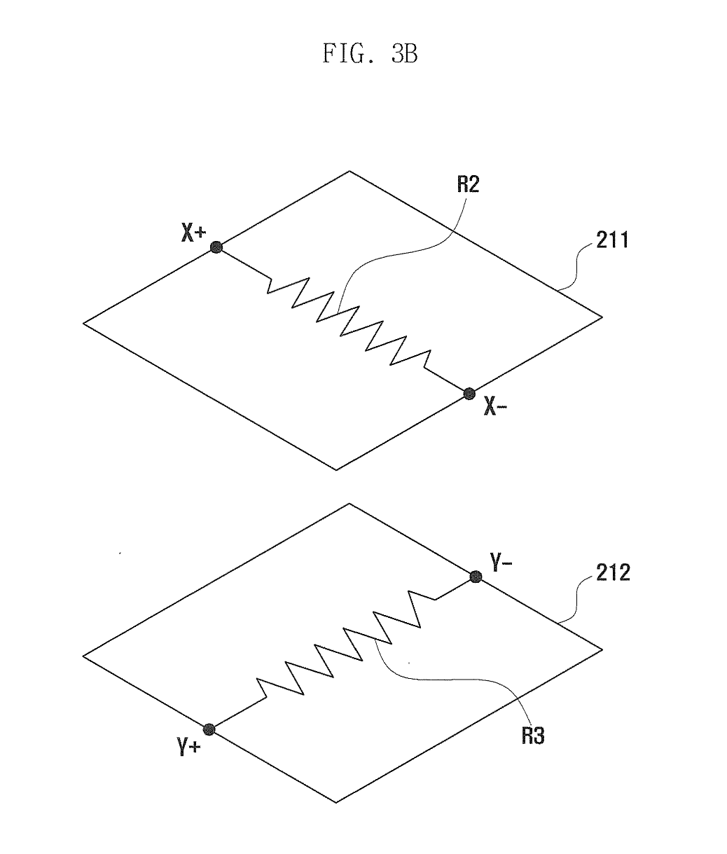

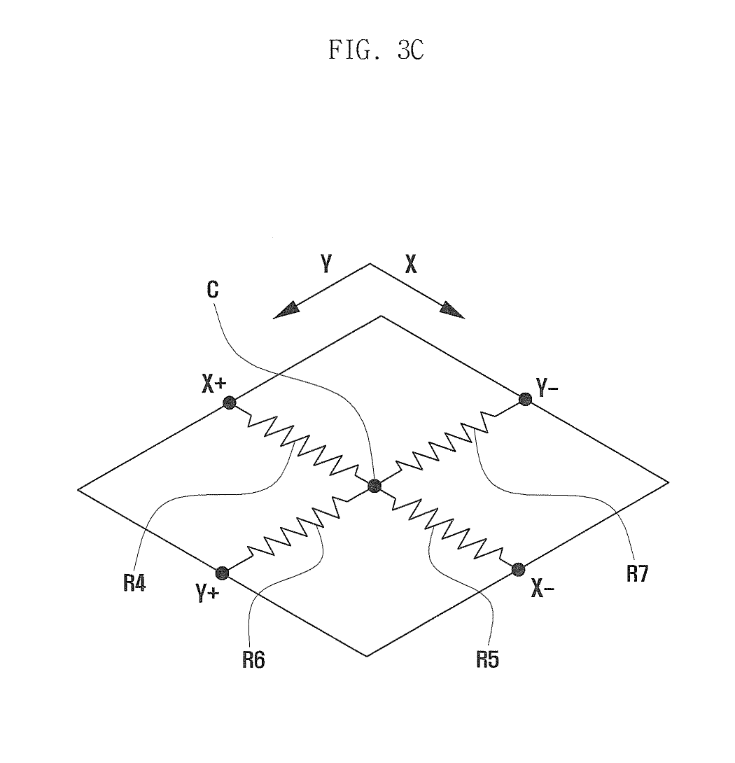

The touch screen panel 210 is preferably a resistive type. The configuration of the touch screen panel 210 is shown in FIG. 3A.

FIG. 3A is an exploded view illustrating the configuration of a touch screen panel in accordance with an embodiment of the present invention.

Referring to FIG. 3A, the touch screen panel 210 includes an upper substrate 211, a lower substrate 212, and a plurality of dot spacers 30 that separate the upper and lower substrates 211 and 212. The upper substrate 211 includes a positive terminal 10 and a negative terminal 11 both of which are elongated along the X-axis (thus, will be hereinafter referred to as X-axis terminals). The lower substrate 212 includes a positive terminal 20 and a negative terminal 21 both of which are elongated along the Y-axis (thus, will be hereinafter referred to as Y-axis terminals). Also, the touch screen panel 210 may further include a cover (not shown) that protects the upper substrate 211, an adhesive layer (not shown) with which the upper and lower substrates 211 and 212 are joined together, and an analog-to-digital converter (ADC) that converts an analog signal into a digital signal. Each of the upper and lower substrates 211 and 212 may be composed of an insulating base and an indium tin oxide (ITO) layer. Now, operation principles of the touch screen panel 210 will be described in detail.

FIGS. 3B and 3C are schematic views illustrating operation principles of a touch screen panel in accordance with an embodiment of the present invention.

Referring to FIGS. 3A, 3B and 3C, when an electric current flows through the upper or lower substrate 211 or 212, a voltage is applied across both terminals of the substrate while the substrate acts as a resistant member providing resistance. Thereafter, when the finger or a stylus pen is touched on a certain place of the touch screen panel 210, the upper substrate 211 is locally bent downward and then comes in contact with the lower substrate 212. Since the resistance of both substrates 211 and 212 is connected in parallel, changes in the resistance value are caused and consequently a voltage between both terminals of the substrate is also varied. The mobile device 200 detects such a variation of a voltage and then finds the coordinates of a touch place.

If there is no touch on the touch screen panel 210, the upper and lower substrates 211 and 212 may be depicted as having resistances corresponding to the second resistor (R2) and the third resistor (R3), respectively, as shown in FIG. 3B. When a user's touch gesture is inputted on the touch screen panel 210, the upper and lower substrates 211 and 212 are in contact with each other at a touch place (C). Therefore, as shown in FIG. 3C, the touch screen panel 210 may be depicted as a circuit having the fourth resistor (R4), the fifth resistor (R5), the sixth resistor (RE) and the seventh resistor (R7).

Specifically, the fourth resistor (R4) corresponds to the resistance between the X-axis positive terminal (X+) and the touch place (C), and the fifth resistance (R5) corresponds to the resistance between the X-axis negative terminal (X−) and the touch place (C). Similarly, the sixth resistance (R6) corresponds to the resistance between the Y-axis positive terminal (Y+) and the touch place (C), and the seventh resistance (R7) corresponds to the resistance between the Y-axis negative terminal (Y−) and the touch place (C). Each resistance value may be varied according to the position of the touch place (C).

If no touch is present on the touch screen panel 210, no resistance exists between any X-axis terminal (X+ or X−) and any Y-axis terminal (Y+ or Y−) since the upper substrates 211 includes only the second resistor (R2) and the lower substrate 212 includes only the third resistor (R3). However, when any touch is inputted on the touch screen panel 210, certain resistance is created between any X-axis terminal and any Y-axis terminal since four resistors (R4, R5, R6 and R7) are made between the touch place (C) and the respective terminals (X+, X−, Y+ and Y−).

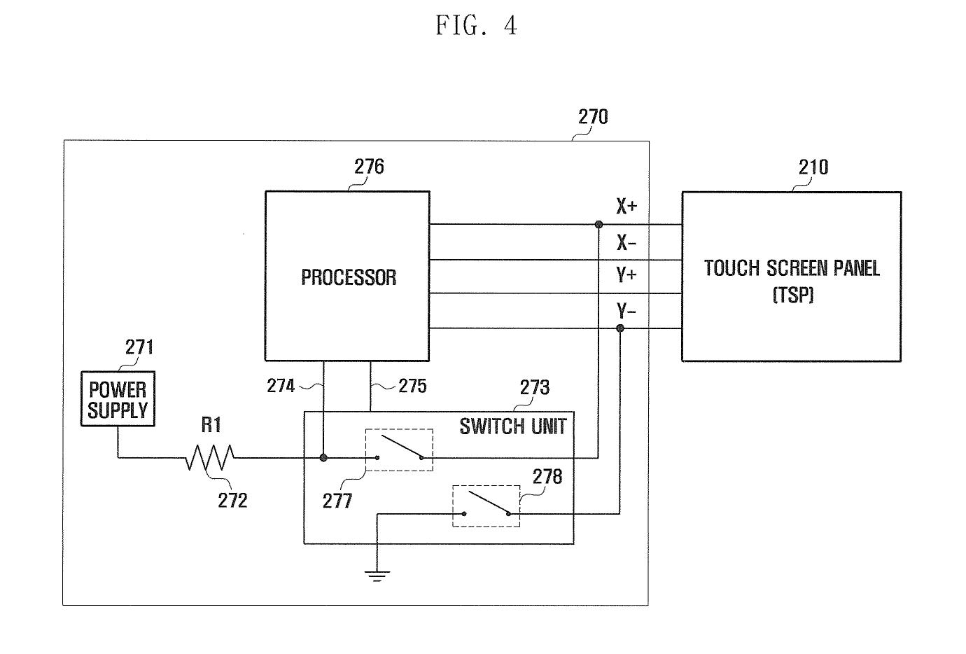

Each of the terminals (X+, X−, Y+ and Y−) on the touch screen panel 210 is connected to a processor (e.g., 276 shown in FIG. 4) in the control unit 270. In some embodiments of this invention, the mobile device 200 may further include a touch screen panel (TSP) driver (not shown), and the touch screen panel may be connected to the processor 276 through the TSP driver. In such embodiments, the TSP driver may calculate the coordinates of the touch place on the touch screen panel 210 by using output voltages of the respective terminals (X+, X−, Y+ and Y−).

For instance, if a driving voltage (Vcc) is applied to the X-axis positive terminal (X+) with the X-axis negative terminal (X−) grounded, the output voltage of the Y-axis terminals (Y+ and Y−) is measured as Vcc*(R4/R4+R5). Since the magnitude of the fourth resistance (R4) is proportional to a distance between the X-axis positive terminal (X+) and the touch place (C), the X coordinates of the touch place (C) can be found from the value of a measured voltage of the Y-axis terminal (Y+ or Y−). Similarly, when a driving voltage (Vcc) is applied to the Y-axis positive terminal (Y+) with the Y-axis negative terminal (Y−) grounded, the output voltage of the X-axis terminals (X+ and X−) is measured as Vcc*(R6/R6+R7). Since the magnitude of the sixth resistance (R6) is proportional to a distance between the Y-axis positive terminal (Y+) and the touch place (C), the Y coordinates of the touch place (C) can be found from the value of a measured voltage of the X-axis terminal (X+ or X−). According to embodiments of this invention, the TSP driver may be included in the control unit 270 or combined with the touch screen panel 210.

Returning to FIG. 2, the audio processing unit 220 may include a codec which may be composed of a data codec for processing packet data and an audio codec for processing an audio signal such as a voice. The audio processing unit 220 converts a digital audio signal into an analog audio signal through the audio codec and then outputs it through a receiver (RCV) or a speaker (SPK), and also converts an analog audio signal received from a microphone (MIC) into a digital audio signal through the audio codec. According to an embodiment of this invention, the audio processing unit 220 may perform an alarm function, by means of a predetermined sound, to warn a user of a continuous pressure applied on the touch screen panel 210.

The vibration generating unit 230 includes a vibration motor and performs a function to generate a vibration under the control of the control unit 270. According to an embodiment of this invention, the vibration generating unit 230 may perform an alarm function, by means of a predetermined vibration pattern, to warn a user of a continuous pressure applied on the touch screen panel 210.

The memory unit 240 stores programs and data provided for operations of the mobile device 200 and may consist of a program region and a data region. The program region may store an operating system (OS) for booting and operating the mobile device 200, applications for replaying multimedia contents, and applications for executing various optional functions of the mobile device 200, such as a camera function, a sound reproduction function, an image or video play function, and the like. According to an embodiment of this invention, the memory unit 240 may store a specific application for performing an alarm function to warn a user of a continuous pressure applied on the touch screen panel 210.

The data region stores data created while the mobile device 200 is used, such as images, videos, a phonebook, audio data, and the like. According to embodiments of this invention, the memory unit 240 may store information about a critical time used to determine whether a continuous pressure is applied on the touch screen panel 210. Additionally, the memory unit 240 may store information about a critical voltage used to determine whether a pressure is applied on the touch screen panel 210.

The display unit 250 may be formed of LCD (Liquid Crystal Display), OLED (Organic Light Emitting Diode), AMOLED (Active Matrix OLED), or any equivalent. The display unit 250 visually offers a menu, input data, function setting information, and any other various information of the mobile device 200 to a user. The display unit 250 performs a function to output a booting screen, an idle screen, a menu screen, a call screen, or any other application screens of the mobile device 200. According to an embodiment of this invention, the display unit 250 is combined with the touch screen panel 210, so that both the display unit 250 and the touch screen panel 210 may form a normal touch screen unit. Additionally, the display unit 250 may output a message to warn a user of a continuous pressure applied on the touch screen panel 210.

The key input unit 260 receives a user's key manipulation for controlling the mobile device 200, creates a corresponding input signal, and then delivers it to the control unit 270. The key input unit 260 may be formed of a keypad that includes alphanumeric keys and navigation keys and disposed at the front side of the mobile device 200, and some function keys disposed at lateral sides of the mobile device 200. If the touch screen panel 210 is enough to manipulate the mobile device, the key input unit 260 may be omitted. According to embodiments of this invention, the key input unit 260 may include a special function key used for allowing the mobile device 200 to enter into a sleep mode.

The control unit 270 performs a function to control the whole operation of the mobile device 200 and to control the flow of signals between internal blocks of the mobile device 200. According to embodiments of this invention, the control unit 270 determines whether a command to switch to a sleep mode is inputted. Herein, the sleep mode refers to a state in which the mobile device 200 does not recognize the coordinates of a touch input even though any touch is inputted on the touch screen panel 210. The control unit 270 may control the key input unit 260 and thereby determine whether a function key for switching to the sleep mode is selected. Alternatively, if a sleep mode entry is compelled when there is no input on the touch screen panel 210 or the key input unit 260 for a given time, the control unit 270 may determine whether the given time elapses after the last input on the touch screen panel 210 or the key input unit 260.

When a command to switch to the sleep mode is inputted, the control unit 270 allows the mobile device 200 to enter into the sleep mode. Specifically, the control unit 270 may turn off the display unit 250 or inactivate the touch screen panel 210. Additionally, the control unit 270 determines whether a pressure is continuously applied on the touch screen panel 210 in the sleep mode, and if so, further determines whether a continuous pressure is maintained more than a predefined critical time. If the duration of a continuous pressure is greater than a critical time, the control unit 270 performs an alarm function by outputting a vibration through the vibration generating unit 230, by outputting a sound through the audio processing unit 220, or by outputting a message through the display unit 250. A process of determining whether a pressure is continuously applied on the touch screen panel 210 in the sleep mode is implemented by elements in the control unit 270. This will be described in detail with reference to FIG. 4.

In addition to the elements discussed above, the mobile device 200 according to embodiments of this invention may essentially or selectively include any other elements such as a radio frequency unit, a camera module, a digital broadcast receiving module, a connector terminal used for a data exchange with any external digital equipment, a terminal for recharging a battery, a digital sound replay module (e.g., an MP3 module), and the like. According to a digital convergence tendency today, such elements may be varied, modified and improved in various ways, and any other elements equivalent to the above elements may be additionally or alternatively equipped in the mobile device 200. As will be understood by those skilled in the art, some of the above-mentioned elements in the mobile device 200 may be omitted or replaced with another.

FIG. 4 is a block diagram illustrating the configuration of a control unit of a mobile device in accordance with an embodiment of the present invention.

Referring to FIG. 4, the control unit 270 according to an embodiment of this invention includes a power supply 271, the first resistor (R1) 272, a switch unit 273, a measure voltage line 274, a switch unit control line 275, and a processor 276. Additionally, the switch unit 273 includes the first switch 277 and the second switch 278.

The power supply 271 generates a direct-current (DC) voltage and outputs it to a power input terminal of the switch unit 273. Even when the mobile device 200 is in the sleep mode, the power supply 271 outputs a DC voltage to the switch unit 273. According to an embodiment of this invention, the power supply 271 may generate a DC voltage of 5.0 volt and supply it to the switch unit 273.

The first resistor (R1) 272 is connected between the power supply 271 and the switch unit 273 and affects a voltage measured through the measure voltage line 274 by the processor 276. According to an embodiment of this invention, the first resistor (R1) 272 may become a target of voltage measurement by the processor 276. In this embodiment, when the mobile device 200 enters into the sleep mode, the processor 276 measures a voltage applied to the first resistor (R1) 272. Preferably, the first resistor (R1) 272 has a resistance of about 150 kΩ. If there is any internal resistance connected to the measure voltage line 274 in the processor 276, the first resistor (R1) 272 may be omitted.

The switch unit 273 is controlled by the processor 276 and closes the first and second switches 277 and 278 when the mobile device 200 enters into the sleep mode. The switch unit 273 is connected to the processor 276 through the measure voltage line 274, and the processor 276 measures a voltage at a connection point with the measure voltage line 274. Additionally, the switch unit 273 is further connected to the processor 276 through the switch unit control line 275, and the processor 276 transmits a control signal to the switch unit 273 through the switch unit control line 275. As mentioned above, the switch unit 273 includes the first switch 277 and the second switch 278. The first switch 277 is connected at one end thereof to the X-axis positive terminal (X+) of the touch screen panel 210 and also connected at the other end thereof to both the processor 276 and the first resistor (R1) 272. The second switch 278 is connected at one end thereof to the Y-axis negative terminal (Y−) of the touch screen panel 210 and also grounded at the other end thereof. In other various embodiments of this invention, one end of the first and second switches 277 and 278 may be respectively connected to the X-axis positive terminal (X+) and the Y-axis positive terminal (Y+), to the X-axis negative terminal (X−) and the Y-axis positive terminal (Y+), to the X-axis negative terminal (X−) and the Y-axis negative terminal (Y−), to the Y-axis positive terminal (Y+) and the X-axis positive terminal (X+), to the Y-axis positive terminal (Y+) and the X-axis negative terminal (X−), to the Y-axis negative terminal (Y−) and the X-axis positive terminal (X+), or to the Y-axis negative terminal (Y−) and the X-axis negative terminal (X−).

The processor 276 may be formed of a main processor (e.g., a mobile station modem (MSM) baseband device) that performs a function to control the whole operation of the mobile device 200. According to an embodiment of this invention, the processor 276 may be formed of an application processor that controls the touch screen panel 210. The processor 276 determines whether a sleep mode entry command is inputted, by controlling the key input unit 260 to check whether a function key for switching to the sleep mode is selected, or by checking whether a given time elapses after the last input on the touch screen panel 210 or the key input unit 260. When a sleep mode entry command is inputted in the mobile device 200, the processor 276 allows the mobile device 200 to enter into the sleep mode. Namely, the processor 276 turns off the display unit 250 or inactivates the touch screen panel 210.

After the mobile device 200 enters into the sleep mode, the processor 276 controls the switch unit 273 to close the first and second switches 277 and 278 and then measures a voltage at a connection point with the measure voltage line 274. Specifically, the processor 276 is connected to the measure voltage line 274 at a general purpose input/output (GPIO) and measures a voltage at the GPIO. When no pressure is applied to the touch screen panel 210, no resistance exists between any X-axis terminal (X+ or X−) and any Y-axis terminal (Y+ or Y−) and therefore a voltage generated by the power supply 271 is applied to the first resistor (R1) 272 or to any internal resistance connected to the measure voltage line 274 in the processor 276. If the processor 276 measures, at the GPIO, such a voltage applied to the first resistor (R1) 272 or applied to any internal resistance connected to the measure voltage line 274 in the processor 276, a measured voltage may indicate a regular value while the touch screen panel 210 receives no pressure.

According to an embodiment of this invention, the processor 276 may measure, at the GPIO, a voltage applied to any resistance of the touch screen panel 210. If no pressure is applied to the touch screen panel 210, the processor 276 recognizes a voltage to be ‘0V’ since there is no resistance between any X-axis terminal (X+ or X−) and any Y-axis terminal (Y+ or Y−) of the touch screen panel 210.

When a pressure is applied to the touch screen panel 210, a resistance is made between the touch place and each of the X-axis positive terminal (X+), the X-axis negative terminal (X−), the Y-axis positive terminal (Y+), and the Y-axis negative terminal (Y−), and also a resistance is created between any X-axis terminal (X+ or X−) and any Y-axis terminal (Y+ or Y−). A voltage generated by the power supply 271 is distributed to resistances in the touch screen panel 210. Therefore, when the processor 276 measures a voltage applied to the first resistor (R1) 272 or to any internal resistance connected to the measure voltage line 274 in the processor 276, a reduced voltage is measured.

In an embodiment of this invention, when the processor 276 measures a voltage applied to any resistance in the touch screen panel 210 while a pressure is applied to the touch screen panel 210, an increased voltage is measured.

If a voltage is varied, the processor 276 measures the duration of a varied voltage and determines whether a measured duration is greater than a predefined critical time. If so, the processor 276 may warn a user of a continuous pressure applied on the touch screen panel 210 by outputting a vibration through the vibration generating unit 230, by outputting a sound through the audio processing unit 220, or by outputting a particular graphic user interface (GUI) through the display unit 250.

Now, a management method for the touch screen panel 210 will be described through an embodiment of this invention.

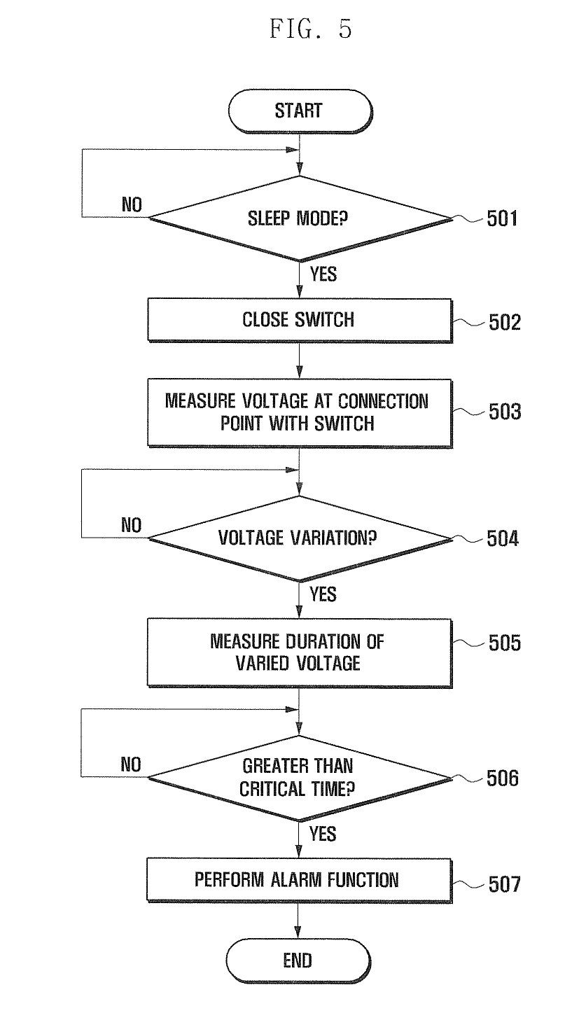

FIG. 5 is a flow diagram illustrating a method for managing a touch screen panel in accordance with an embodiment of the present invention. A process flow shown in FIG. 5 is accomplished under the control of the processor 276 shown in FIG. 4 and is hereinafter described with reference to FIGS. 4 and 5.

At the outset, the processor 276 determines whether a sleep mode entry command is inputted (block 501). The processor 276 may control the key input unit 260 and thereby determine whether a function key for switching to the sleep mode is selected. Alternatively, if a sleep mode entry is compelled when there is no input on the touch screen panel 210 or the key input unit 260 for a given time, the processor 276 may determine whether the given time elapses after the last input on the touch screen panel 210 or the key input unit 260.

When a sleep mode entry command is inputted, the processor 276 allows the mobile device 200 to enter into the sleep mode. Specifically, the processor 276 may turn off the display unit 250 or inactivate the touch screen panel 210. Herein, the touch screen panel 210 in the inactive state does not compute the coordinates of a touch input even if any touch is inputted thereon.

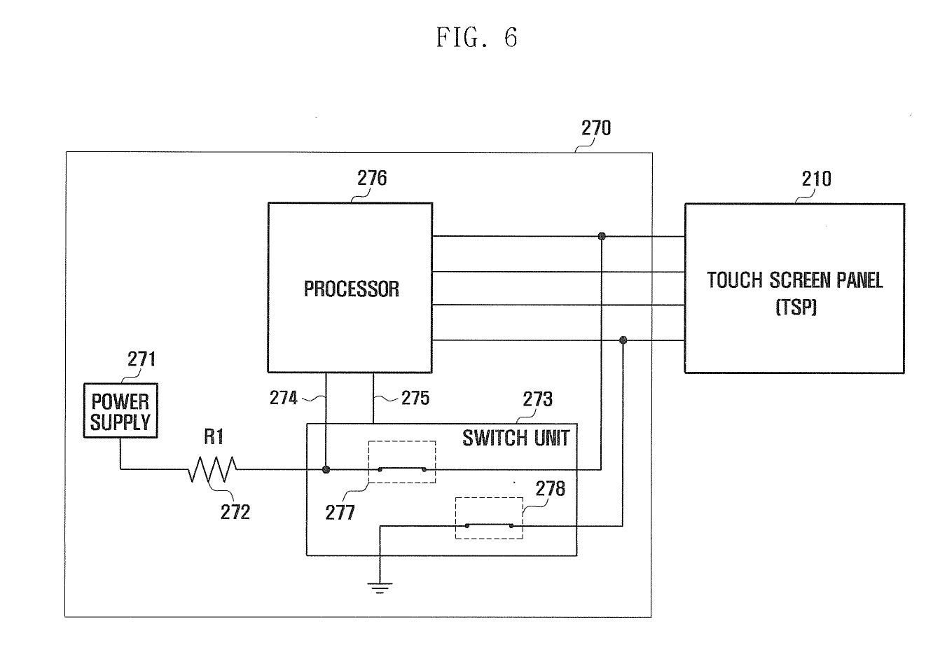

After the mobile device 200 enters into the sleep mode, the processor 276 controls the switch unit 273 and closes the first and second switches 277 and 278 (block 502). Through the switch unit control line 275, the processor 276 drives the switch unit 273 and transmits a control signal for closing the first and second switches 277 and 278 to the switch unit 273. On receipt of a control signal from the processor 276, the switch unit 273 closes the first and second switches 277 and 278. This state is shown in FIG. 6. Referring to FIG. 6, when the first and second switches 277 and 278 are closed, the first resistor (R1) 272 is connected to the X-axis positive terminal. However, according to variations in circuit design, the first resistor (R1) 272 may be connected to the X-axis negative terminal, the Y-axis positive terminal or the Y-axis negative terminal. Additionally, although the Y-axis negative terminal is grounded in FIG. 6, the X-axis positive terminal, the X-axis negative terminal or the Y-axis positive may be alternatively grounded according to variations in circuit design.

Next, the processor 276 measures a voltage at a connection point with the switch unit 273 (block 503) and determines whether a variation in voltage occurs (block 504). Specifically, in the block 503, the processor 276 may measure a voltage applied to the measure voltage line 274. When no pressure is applied to the touch screen panel 210, no resistance exists between any X-axis terminal (X+ or X−) and any Y-axis terminal (Y+ or Y−). Therefore, until any pressure is applied to the touch screen panel 210, a voltage generated by the power supply 271 is applied to the first resistor (R1) 272 or to any internal resistance connected to the measure voltage line 274 in the processor 276. The processor 276 measures the voltage of the measure voltage line 274 at the GPIO. The processor 276 may measure a voltage applied to the first resistor (R1) 272 or applied to any internal resistance connected to the measure voltage line 274 in the processor 276. While the touch screen panel 210 receives no pressure, the voltage of the measure voltage line 274 is measured as a regular value. In another embodiment of this invention, the processor 276 may measure, at the GPIO, a voltage applied to any resistance of the touch screen panel 210. While the touch screen panel 210 receives no pressure, the processor 276 recognizes a voltage to be ‘0V’ since there is no resistance between any X-axis terminal and any Y-axis terminal of the touch screen panel 210.

When a pressure is applied to the touch screen panel 210, a resistance is made between the touch place and each of the X-axis positive terminal (X+), the X-axis negative terminal (X−), the Y-axis positive terminal (Y+), and the Y-axis negative terminal (Y−), and therefore a resistance is created between any X-axis terminal (X+ or X−) and any Y-axis terminal (Y+ or Y−). A voltage generated by the power supply 271 is also applied to resistances created in the touch screen panel 210. Therefore, when the processor 276 measures a voltage applied to the first resistor (R1) 272 or applied to any internal resistance connected to the measure voltage line 274 in the processor 276, a reduced voltage is measured. In another embodiment of this invention, the processor 276 may measure a voltage distribution value between the first resistor (R1) 272 and any resistance created in the touch screen panel 210. When the processor 276 measures a voltage applied to any resistance created in the touch screen panel 210, an increased voltage is measured while a pressure is applied to the touch screen panel 210.

In an embodiment of this invention, the processor 276 may determine whether a voltage measured at a connection point with the measure voltage line 274 satisfies a given voltage range. When a pressure is applied to the touch screen panel 210, resistance created may be about 400˜600Ω. When a voltage generated by the power source 271 is distributed to the first resistor (R1) 272 and any resistance created in the touch screen panel 210, the processor 276 may determine whether the value of a voltage applied to the first resistor (R1) 272 is within a given voltage range and whether the value of a voltage applied to the resistance created in the touch screen panel 210 is within a given voltage range. Specifically, the processor 276 may determine whether the value of a voltage applied to the first resistor (R1) 272 is smaller than a predefined critical voltage and whether the value of a voltage applied to the resistance created in the touch screen panel 210 is greater than a predefined critical voltage.

If it is determined in the block 504 that a voltage is varied, the processor 276 measures the duration of a varied voltage (block 505) and determines whether a measured duration is greater than a predefined critical time (block 506). A predefined critical time is determined as a time at which it is needed to warn a user that a continuous pressure is applied on the touch screen panel 210. This critical time may be set as a default in the manufacture of the mobile device 200 and may be changeable through a suitable user menu.

If the duration of a varied voltage is greater than a critical time, the processor 276 performs an alarm function (block 507). According to some embodiments of this invention, in order to warn a user that a continuous pressure is applied on the touch screen panel 210, the processor 276 may output a vibration through the vibration generating unit 230, output a sound through the audio processing unit 220, or output a particular GUI through the display unit 250. Here, a vibration output may have a specific pattern, and also a sound output may be prearranged.

As fully discussed hereinbefore, the mobile device 200 according to this invention determines whether a pressure is continuously applied on the touch screen panel 210 in the sleep mode, and if so, performs an alarm function by means of a vibration output, a sound output, a GUI output, and the like. Therefore, the mobile device 200 can prevent improper operations or troubles of the touch screen panel 210.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile device comprising:
a touch screen panel comprising a first terminal and a second terminal and configured to create a resistance between the first and second terminals when a touch is inputted thereon;
a power supply configured to generate a voltage;
a processor configured to measure a voltage at a connection point with the power supply in a sleep mode, when the measured voltage is varied, to measure the duration of the varied voltage, and then to determine whether the measured duration is greater than a predefined critical time;
a first switch connected at one end thereof to the first terminal, connected at the other end thereof to both the power supply and the processor, and closed in the sleep mode;
a second switch connected at one end thereof to the second terminal, grounded at the other end thereof, and closed in the sleep mode; and
an output unit configured to output at least one of a vibration and a sound when the measured duration is greater than the critical time.

2. The mobile device of claim 1, wherein the first terminal is one of an X-axis positive terminal and an X-axis negative terminal in the touch screen panel.

3. The mobile device of claim 1, wherein the second terminal is one of a Y-axis positive terminal and a Y-axis negative terminal in the touch screen panel.

4. The mobile device of claim 1, wherein the processor is further configured to measure a voltage applied between the first and second terminals.

5. The mobile device of claim 1, further comprising:
a resistor connected between the power supply and the first switch.

6. The mobile device of claim 5, wherein the processor is further configured to measure a voltage applied to the resistor.

7. The mobile device of claim 5, wherein the processor is further configured to measure, when a touch is inputted, a distribution value of voltage between the voltage applied to the resistor and a voltage made between the first and second terminals.

8. The mobile device of claim 4, wherein the processor is further configured to determine whether the voltage applied between the first and second terminals is greater than a predefined critical voltage.

9. The mobile device of claim 6, wherein the processor is further configured to determine whether the voltage applied to the resistor is smaller than a predefined critical voltage.

10. The mobile device of claim 1, further comprising:
a display unit configured to output a message to warn a user that a continuous pressure is applied on the touch screen panel.

11. A method for managing a touch screen panel of a mobile device which comprises the touch screen panel comprising a first terminal and a second terminal, a power supply, a processor, a first switch connected at one end thereof to the first terminal and connected at the other end thereof to both the power supply and the processor, and a second switch connected at one end thereof to the second terminal and grounded at the other end thereof, the method comprising:
closing the first and second switches in a sleep mode;
measuring a voltage at a connection point with the first switch;
determining whether the measured voltage is varied;
when the measured voltage is varied, measuring the duration of the varied voltage; and
outputting at least one of a vibration and a sound when the measured duration is greater than a predefined critical time.

12. The method of claim 11, wherein the measuring of the voltage comprises measuring a voltage applied between the first and second terminals.

13. The method of claim 11, wherein the mobile device further comprises a resistor connected between the power supply and the first switch.

14. The method of claim 13, wherein the measuring of the voltage comprises measuring a voltage applied to the resistor.

15. The method of claim 13, wherein the measuring of the voltage includes measuring, when a touch is inputted, a distribution value of voltage between the voltage applied to the resistor and a voltage applied between the first and second terminals.

16. The method of claim 11, further comprising:
outputting a message to warn a user that a continuous pressure is applied on the touch screen panel.
